(19) United States
(12) Patent Application Publication
(10) Pub. No.: US 2009/0321191 A1
(43) Pub. Date: Dec. 31, 2009

(54) Drive mechanism for lifting device

(76) Inventor: Frederick Kenneth Broyan, Berwick, PA (US)

Correspondence Address: THOMAS R SHAFFER;GLASSMIRE & SHAFFER LAW OFFICES, PC, 5 EAST THIRD STREET, P O BOX 509, COUDERSPORT, PA, 16915, US

(21) Appl. No.: 12/459,928

(22) Filed: Jul. 8, 2009

Related U.S. Application Data
(63) Continuation of application No. 11/375,182, filed on Mar. 13, 2006.

(51) Int. Cl. B66B 11/08

(52) U.S. Cl. 187/255

(57) ABSTRACT

An improved pre-assembled drive mechanism is disclosed for a lifting device of the type having a container movable upwardly and downwardly on spaced apart guide rails. A generally cylindrical motorized tooth drive having a plurality of drive teeth on an outer cylindrical wall is provided. The drive teeth are adapted to be received by spaces between the teeth of the drive belt. A belt guide roller is mounted in close proximity upstream to the drive pulley. The belt guide roller is provided to maintain proper alignment of the toothed belt relative to the drive pulley and to retrain the lateral movement of the toothed belt portion. A direction reversing idler pulley is adapted to receive and guide the toothed belt in a manner such that the toothed belt portion stays in driving engagement with the drive pulley for a substantial distance around the drive pulleys rotational path of travel.

This application is a Continuation of U.S. patent application Ser. No. 11/375,182, filed Mar. 13, 2006. A drive mechanism for a lifting device is disclosed. More specifically, a preassembled unit which includes a motorized toothed drive pulley, a belt drive roller and a direction reversing idler pulley is disclosed.

The drive mechanism of the present invention is an improved drive mechanism for a lifting device of the type generally described and shown in Applicant's earlier U.S. Pat. No. 6,425,463 issued Jul. 30, 2002. A copy of said patent is attached hereto and incorporated herein by reference.

In addition to the prior art described in Applicant's earlier U.S. Pat. No. 6,425,463, various other devices are known.

U.S. Pat. No. 6,305,499 to Jones et al. discloses a drum drive elevator which utilizes a flat belt.

Gottlieb et al., U.S. Pat. No. 6,776,263, discloses an elevator to transport loads in an aircraft which discloses the use of a toothed belt drive mechanism.

Keilty et al., U.S. Pat. No. 5,482,511, discloses a belt drive mechanism which includes a toothed pulley and a toothed belt.

Slagle, U.S. Pat. No. 6,779,634, discloses a dumb waiter which utilizes cables and pulleys to raise and lower the platform.

Gregg, U.S. Pat. No. 5,421,789, discloses a drive pulley having pulley cavities which are complementary to a synchronous drive belt which has at least two adjacent rows of teeth which are at oppositely balanced oblique angles to the longitudinal direction of the belt.

Gregg, U.S. Pat. No. 3,969,946, discloses a belt for use in a synchronous drive which includes uniformly spaced teeth of similar shape around the inner periphery to engage the toothed gears to form the drive.

Hunkert, U.S. Pat. No. 6,050,916, discloses a toothed belt drive which has at least one toothed gear wheel and at least one toothed belt. Hunkert teaches the provision of at least one tooth of the toothed belt which has a flank geometry which is different from that of each of the other teeth.

While the drive mechanism disclosed in Applicant's earlier U.S. Pat. No. 6,425,463 is effective, there remains a need for a drive mechanism which is easier to install and one which provides a safer and more efficient means of lifting and lowering the container.

### SUMMARY OF THE INVENTION

In its simplest form, an improved drive mechanism for a lifting device is disclosed of the type having a container movable upwardly and downwardly on spaced apart guide rails and having a drive belt loop attached to an upper end of said container and to a lower end of said container, said drive belt loop having a toothed belt portion with a plurality of belt teeth on a first side thereof and a generally flat surface on a second side thereof, wherein the improvement comprises: a) a generally cylindrical motorized toothed drive pulley having a plurality of drive teeth on an outer cylindrical wall thereof, said drive teeth adapted to be received by spaces between said belt teeth of said first side of said toothed belt portion; b) a belt guide roller mounted in close proximity upstream to said drive pulley, said belt guide roller adapted to contact said second side of said toothed belt portion and to contact opposite sides of said toothed belt portion to maintain proper alignment of said toothed belt portion relative to said drive pulley and to restrain lateral movement of said toothed belt portion; c) a direction reversing idler pulley adapted to receive and guide said first side of said toothed belt portion, said reversing idler pulley mounted in close proximity downstream to said drive pulley, said direction reversing idler pulley also mounted in close proximity and downstream to said belt guide roller whereby said reversing idler pulley causes said toothed belt portion to said in driving engagement with said drive pulley for a substantial distance around the drive pulleys rotational travel.

Preferably, the substantial distance is at least 180°.

Preferably, the drive mechanism is preassembled into a single unit onto a frame member to allow for easy installation.

Preferably, the drive pulley, said belt guide roller and said idler puller are mounted, respectively on a first shaft, a second shaft and a third shaft, said first shaft, said second shaft and said third shaft each mounted for rotation parallel to each other between two spaced apart parallel plate members.

Preferably, said plate members are mounted to a frame base member, said frame base member also having a motor mounted thereon, said motor having a drive shaft connected to said second shaft for driving said drive pulley.

Preferably, said first shaft, said second shaft and said third shaft are spaced apart from one another in a triangular relationship.

Preferably, said belt guide roller is located vertically between said drive pulley and said idler pulley.

Preferably, said toothed belt portion is formed of a strong flexible material.

Preferably, said toothed belt portion is formed of urethane with steel or fabric cords.

Preferably, said belt teeth each have a semicircular cross sectional configuration.

Preferably, each tooth has a base portion which has parallel walls.

Preferably, a toothed belt has an end folded over onto a middle portion of the belt with teeth engaging space between other teeth and forming a loop, said end secured to said middle with a metal sleeve crimped onto said end and middle portion of said belt.

Preferably, the toothed belt has a D hook inserted in said loop and has a wire rope attached to said D hook.

### BRIEF DESCRIPTION OF THE DRAWINGS

FIG. 1 is a perspective view of the drive mechanism of the present invention.

FIG. 2 is a side schematic view of the drive mechanism of the present invention.

FIG. 3 is a side schematic view of the drive of the present invention as attached to an elevator container.

FIG. 4 is a cross-sectional view of a drive belt according to the present invention.

FIG. 5 is a cross-sectional view showing the attachment of a toothed belt portion to a D ring for attachment to a wire rope.

Referring to the figures, a drive mechanism 10 is disclosed which has a frame member 20. Mounted to said frame member 20 is a U-shaped sub frame 30 which has a pair of spaced apart parallel walls 32 and 34. Mounted between said parallel walls 32 and 34 are three shafts. A first shaft 42 is rotatably mounted between said parallel walls 32 and 34 for mounting of a belt guide roller 40. The belt guide roller 40 has a pair of collar members 44 which act to secure a toothed belt 110 in a proper position. The sub frame 30 also has a second shaft 52 which is powered by a motor 70 and which is adapted to turn the generally cylindrical motorized toothed drive pulley 50. Drive pulley 50 has a plurality of teeth 53 on an outer cylindrical wall thereof. The teeth are adapted to be received by spaces 111 (see FIG. 4) between adjacent teeth 113 on a toothed first side 112 of a toothed belt portion 110 of a drive belt loop 100.

A third shaft 62 is mounted between parallel plates 32 and 34 onto which a direction reversing idler pulley 60 is provided. As shown in FIG. 1, a belt toothed portion 110 of the drive belt loop 110 has a first toothed side 112 and a second flat side 114. The direction reversing idler pulley 60 is mounted in such a position as to cause the toothed drive belt portion 110 to stay engaged with the motorized toothed drive pulley 50 for a substantial distance around the drive pulleys 50 rotational travel.

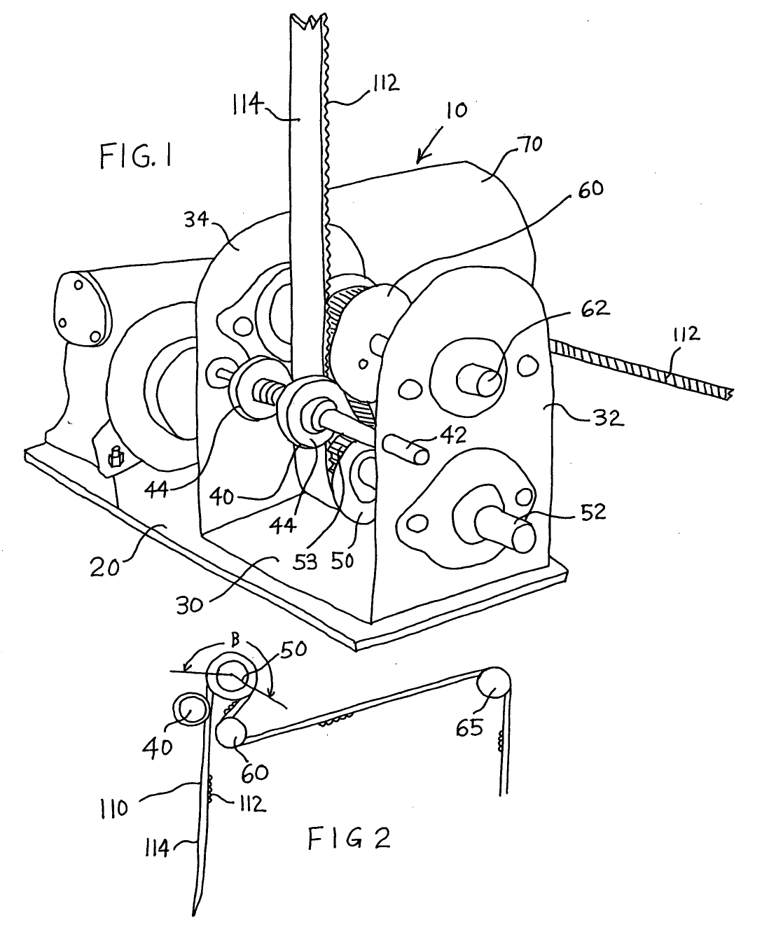

As shown in FIG. 2, such rotational distance is shown by angle B which is shown to be in excess of 180°. FIGS. 2 shows a substantial distance (angle of engagement) B of approximately 220 degrees.

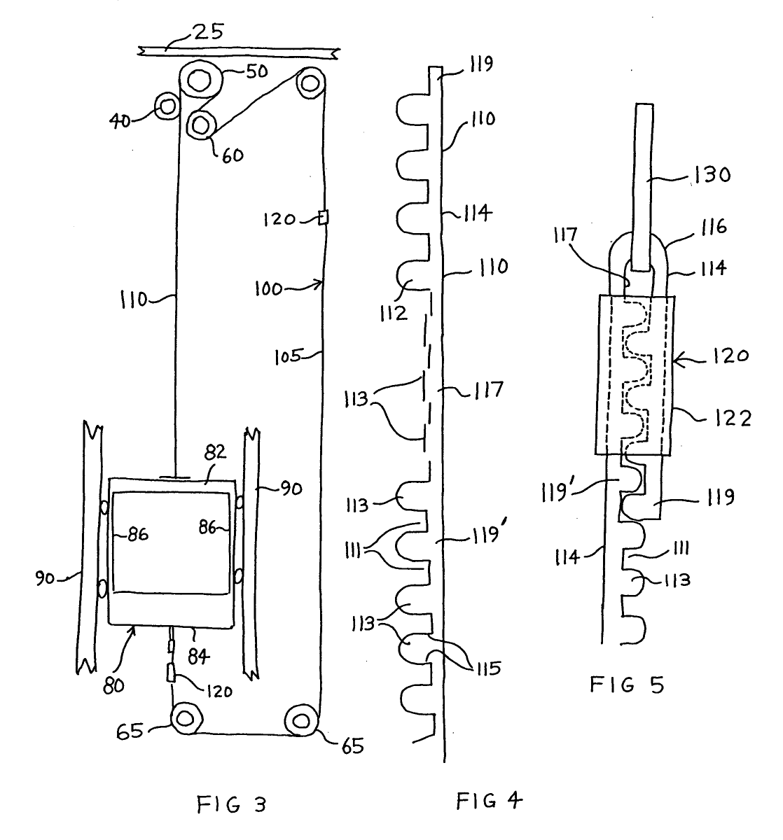

As can also be seen from FIG. 2, the toothed belt portion 110 first comes into contact with belt guide roller 40, then engages the toothed drive pulley 50 and then has its direction reversed by direction reversing idler 60. The remainder of the loop 100 is shown in FIG. 3. Referring to FIG. 3, the belt loop 100 is formed of a toothed belt portion 110 and a wire rope portion 105. The connection of these two components occurs by means of a coupling member 120 which is described in detail with reference to FIGS. 4 and 5. The belt loop 100 is attached to the upper end of an elevator container 82 and is also attached at an opposite end to a lower end 84 of an elevator container 80. The elevator container 80 is adapted to slide upwardly and downwardly between spaced apart guide rails 90 which engage with opposite sides 86 of the elevator container 80. A plurality of additional idler pulleys 65 are provided to direct the drive belt around drive belt loop 100. It can be seen that the drive belt mechanism shown in FIG. 1 is adapted to be mounted as unit to the roof 25 of a structure as shown in FIG. 3.

Making the connection of a wire rope 105 to the toothed belt portion 110 of the drive belt loop 100 is shown in FIGS. 4 and 5. A number of individual teeth 113 are removed from a central portion 117 of the toothed drive belt portion 110. An end 119 is folded over a central portion 119′ to interlock teeth 113 with spaces 111 as shown in FIG. 5. A loop 116 is formed and a metallic sleeve 122 is slid over the engaged end portion 119 and middle portion 119′ and crimped into place to secure a “D” hook 130 onto loop 116. The D hook 130 is then utilized to attach the wire rope portion 105 to the toothed belt portion 110. The similar coupling is shown below the lower end 84 of the elevator container 80.

The present invention has a number of advantages over the prior art. First, the location and arrangement of the drive pulley 50, belt guide roller 40 and idler pulley 60 keep the belt loop 100 on track and prevent lateral movement of the same. The provision of all of these components 40, 50 and 60 into a single frame 20 allows for greatly reduced installation costs for an elevator system by allowing an installer to merely attach the frame 20 to the ceiling 25 of a structure.

Also, the present invention employs a belt toothed design which has a unique shape. Each tooth 113 on the first side 112 of the toothed belt portion 110 has a semi-circular cross-sectional configuration. Each tooth also has a base portion 115 which include parallel walls. This makes for longer teeth 113 and deeper spaces 111 between adjacent teeth 113. It is noted that the spaces 111 preferably have a flat surface. With this arrangement, the semi-circular outer portion 113 of the teeth quickly slide into an available space 111 and because of the depth of each tooth and each toothed space, a secure drive mechanism is created.

While I have shown and described the presently preferred embodiment of my invention, the invention is not limited thereto and may be otherwise variously practiced within the scope of the following claims:

1. A drive mechanism for a lifting device comprising:
a) a pair of spaced apart guide rails;
b) a container having an upper end and having a lower end, said container movable upwardly and downwardly on said spaced apart guide rails,
c) a drive belt loop attached to said upper end of said container and attached to said lower end of said container, said drive belt loop having a toothed belt portion with a plurality of belt teeth of a first side thereof and a generally flat surface on a second side thereof;
d) a generally cylindrical motorized toothed drive pulley having a plurality of drive teeth on an outer cylindrical wall thereof, said drive teeth adapted to be received by spaces between said belt teeth of said first side of said toothed belt portion, said belt teeth having an elongated semicircular cross sectional configuration with each tooth having a base portion having parallel side walls whereby making longer teeth with deeper spaces between adjacent teeth than teeth which have a semicircular cross sectional configuration without such a parallel side wall base portion;
e) a belt guide roller mounted in close proximity upstream to said drive pulley, said belt guide roller adapted to contact said second side of said toothed belt portion and to contact opposite sides of said toothed belt portion to maintain proper alignment of said toothed belt portion relative to said drive pulley and to restrain lateral movement of said toothed belt portion;
f) a direction reversing idler pulley adapted to receive and guide said first side of said toothed belt portion, said reversing idler pulley mounted in close proximity downstream to said drive pulley, said direction reversing idler pulley also mounted in close proximity and downstream to said belt guide roller whereby said reversing idler pulley causes said toothed belt portion to stay in driving engagement with said drive pulley for a substantial distance around a rotational path of travel of said drive pulley, said substantial distance being in excess of 180 degrees and whereby rotation of said drive pulley causes said container to move upwardly and downwardly on spaced apart guide rails.

2. (canceled)

3. A drive mechanism according to claim 1 wherein said drive mechanism is preassembled as a single unit onto a frame member to allow for easy installation by allowing an installer to merely attach the frame to a ceiling of a structure.

4. A drive mechanism according to claim 1 wherein said drive pulley, said belt guide roller and said idler pulley are mounted, respectively, on a first shaft, a second shaft and a third shaft, said first shaft, said second shaft and said third shaft each mounted for rotation parallel to each other between two spaced apart parallel plate members.

5. A drive mechanism according to claim 4 wherein said plate members are mounted to a frame base member creating a U-shaped sub frame, said frame base member also having a motor mounted thereon, said motor having a drive shaft connected to said second shaft for driving said drive pulley.

6. A drive mechanism according to claim 4 wherein said first shaft, said second shaft and said third shaft are spaced apart from one another in a triangular relationship.

7. A drive mechanism according to claim 1 wherein said belt guide roller is located vertically between said drive pulley and said idler pulley.

8. A drive mechanism according to claim 1 wherein said toothed belt portion is formed of a strong flexible material.

9. A drive mechanism according to claim 1 wherein said toothed belt portion is formed of urethane with steel or fabric cords.

10. (canceled)

11. (canceled)

12. A drive mechanism according to claim 1 wherein the toothed belt has an end folded over onto a middle portion of the belt with teeth engaging space between other teeth and forming a loop, said end secured to said middle with a metal sleeve crimped onto said end and middle portion of said belt.

13. A drive mechanism according to claim 12 wherein the toothed belt has a D hook inserted in said loop and has a wire rope attached to said D hook.

14. A drive mechanism according to claim 1 wherein said substantial distance is approximately 220 degrees.
